(19) United States
(12) Patent Application Publication
(10) Pub. No.: US 2023/0368030 A1
(43) Pub. Date: Nov. 16, 2023

(54) BLOCK-WISE PRUNING OF WEIGHTS IN DEEP NEURAL NETWORK

(71) Applicants: Arnab Raha, San Jose, CA (US); Michael Wu, Belmont, CA (US); Deepak Abraham Mathaikutty, Chandler, AZ (US); Martin Langhammer, Alderbury (GB); Nihat Tunali, San Jose, CA (US)

(72) Inventors: Arnab Raha, San Jose, CA (US); Michael Wu, Belmont, CA (US); Deepak Abraham Mathaikutty, Chandler, AZ (US); Martin Langhammer, Alderbury (GB); Nihat Tunali, San Jose, CA (US)

(21) Appl. No.: 18/358,571

(22) Filed: Jul. 25, 2023

(51) Int. Cl. G06N 3/082; G06N 3/048

(52) U.S. Cl. CPC G06N 3/082; G06N 3/048

(57) ABSTRACT

Weights can be pruned during DNN training to increase sparsity in the weights and reduce the amount of computation required for performing the deep learning operations in DNNs. A DNN layer may have one or more weight tensors corresponding to one or more output channels of the layer. A weight tensor has weights, the values of which are determined by training the DNN. A weight tensor may have a dimension corresponding to the input channels of the layer. The weight tensor may be partitioned into subtensors, each of which has a subset of the input channels. The subtensor may have the same number of input channels. One or more subtensors may be selected, e.g., based on the weights in the one or more subtensors. The weights in a selected subtensor are pruned, e.g., changed to zeros. The weights in an unselected subtensor may be modified by further training the DNN.

### TECHNICAL FIELD

This disclosure relates generally to deep neural networks (DNN), and more specifically, block-wise pruning of weights in DNNs.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. DNN inference also requires computation of activation functions. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 is a block diagram of a DNN system, in accordance with various embodiments.

FIG. 3 illustrates an example convolution, in accordance with various embodiments.

FIG. 4 illustrates data distribution to processing elements (PEs) in a PE array for a deep learning operation, in accordance with various embodiments.

FIG. 5 is a block diagram of a DNN module, in accordance with various embodiments.

FIG. 6 is a block diagram of a compressing module, in accordance with various embodiments.

FIG. 7 illustrates data distribution with increased weight sparsity, in accordance with various embodiments.

FIG. 8 illustrates an example sparsity map, in accordance with various embodiments.

FIG. 9 illustrates an example PE array, in accordance with various embodiments.

FIG. 10 is a block diagram of a PE, in accordance with various embodiments.

FIG. 11 is a flowchart showing a method of pruning weight, in accordance with various embodiments.

FIG. 12 is a block diagram of an example computing device, in accordance with various embodiments.

### DETAILED DESCRIPTION

### Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

Deep learning workloads can pose a significant challenge for both data center and edge applications due to their massive computational and memory bandwidth requirements. These workloads often involve computationally intensive operations (e.g., convolutions, matrix multiplications, etc.) on large datasets. Additionally, improving model accuracies typically leads to an increase in both model parameter sizes and operation counts.

Introducing weight sparsity can provide a dual benefit for deep learning workloads by reducing both compute and memory requirements. Currently available pruning approaches usually aim to reduce the computational cost of deep learning workloads by exploiting zero values in weights to skip MAC operations. There are two categories of pruning approaches: unstructured sparsity approaches and structured (or regular) sparsity approaches. Unstructured sparsity approaches may have no constraints on the locations of the zeros. This can lead to higher sparsity for a specific accuracy target. However, there are very few accelerators that can exploit unstructured sparsity for acceleration due to the hardware complexity associated with it. Unstructured sparsity can result in random memory accesses, which can result in inefficient hardware implementation.

Structured sparsity approaches usually employ a structured sparsity method (e.g., 2:4 sparsity pattern) that induces a fixed number of zeros block-wise to reduce computational cost. In an example method using a 2:4 sparsity pattern, two weights would have to be zero for every four contiguous weights. It can be easier to implement accelerators that can exploit structured sparsity compared to unstructured sparsity. However, the structured sparsity approaches suffer from drawbacks. For instance, structured sparsity is usually tied to a particular DNN accelerator architecture and cannot be used out-of-the-box for other DNN architectures. The reduced flexibility in sparsity can also lead to lower sparsity compared to unstructured sparsity for iso-accuracy.

Embodiments of the present disclosure may improve on at least some of the challenges and issues described above by pruning block-wise weights, e.g., during DNN training. DNN training or inference may be done by using DNN accelerators. A DNN accelerator may include one or more PE arrays. A PE array is an array of PEs that can perform computations in deep learning operations (e.g., convolutions, elementwise operations, pooling operations, etc.) in DNNs. Activations and weights of a deep learning operation may be distributed to PEs in the PE array for performing the computations in the deep learning operation. An example weight pruning approach in the present disclosure may prune weights of a deep learning operation based on data distribution within the PE array for efficient sparsity acceleration and less consumption of memory and power.

In various embodiments of the present disclosure, a deep learning operation in a DNN may have input channels and one or more output channels. An input tensor of the deep learning operation may include input activations in the input channels. An output tensor of the deep learning operation may include output activations in the output channels. The output tensor may be computed by applying one or more weight tensors on the input tensor. A weight tensor may correspond to one of the output channels. A weight tensor may include weights in some or all the input channels. The weights may be determined by training the DNN. The weights can then be pruned to increase sparsity of the weight tensor. To prune a weight tensor, the weight tensor may be partitioned into blocks (also referred to as “weight blocks” or “weight subtensors”), each of which has a subset of the input channels. The weight blocks may have the same number of input channels.

One or more weight blocks may be selected, e.g., based on one or more norms (e.g., L1 norm, L2 norm, etc.) of the weight blocks. The selected weight blocks are pruned, i.e., the weights in each selected block are changed to zeros. The weights in each unselected subtensor may be modified by further training the DNN. The sparsity pattern may be balanced across the output channels. For instance, the same number of weight block(s) may be pruned for different output channels. This can facilitate a balanced reduction of workload across PE columns in the PE array, e.g., in embodiments where the PE columns each process a different output channel.

Block-wise weight pruning in the present disclosure can be hardware amendable and can be implemented for many DNN accelerators without the complexity required for supporting structured or unstructured sparsity. It can result in much higher sparsity acceleration compared to currently available pruning approaches. The overall sparsity bitmap footprint can be reduced as input-channel blocks, rather than points, are tracked. This can lead to storage savings and compute acceleration with minimal or even no drop in DNN accuracy.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN

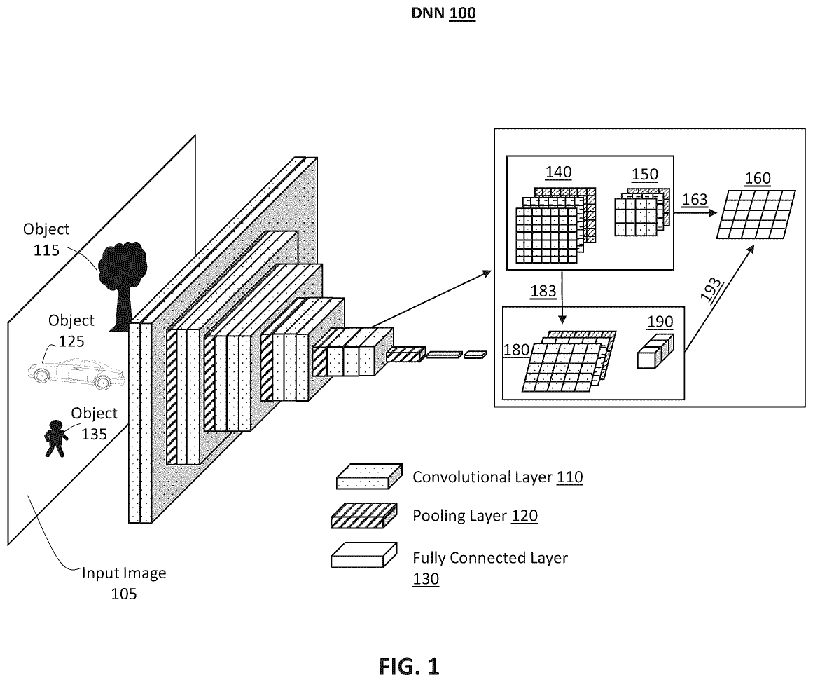

FIG. 1 illustrates an example DNN 100, in accordance with various embodiments. For purpose of illustration, the DNN 100 in FIG. 1 is a CNN. In other embodiments, the DNN 100 may be other types of DNNs, The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3 . The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

### Example DNN System

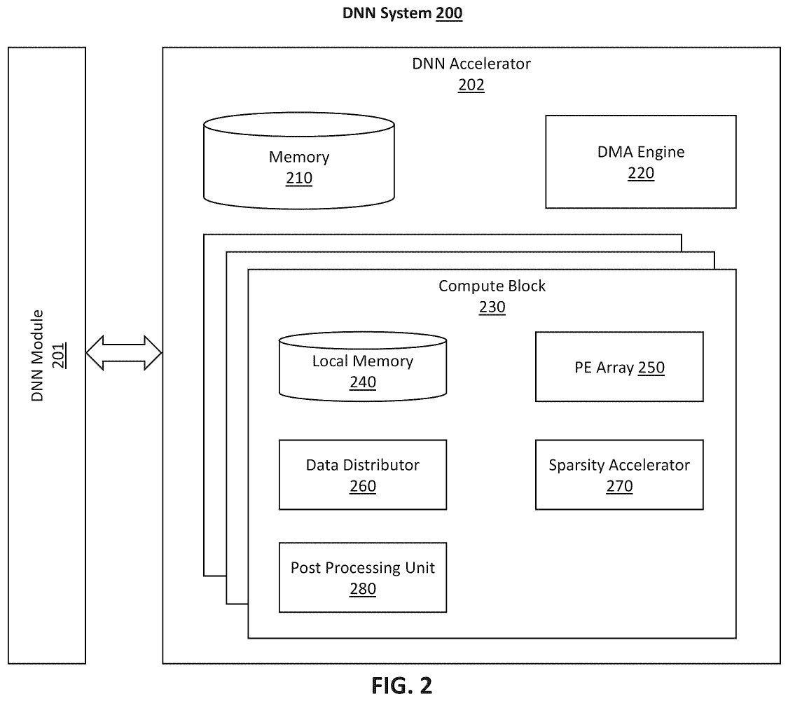

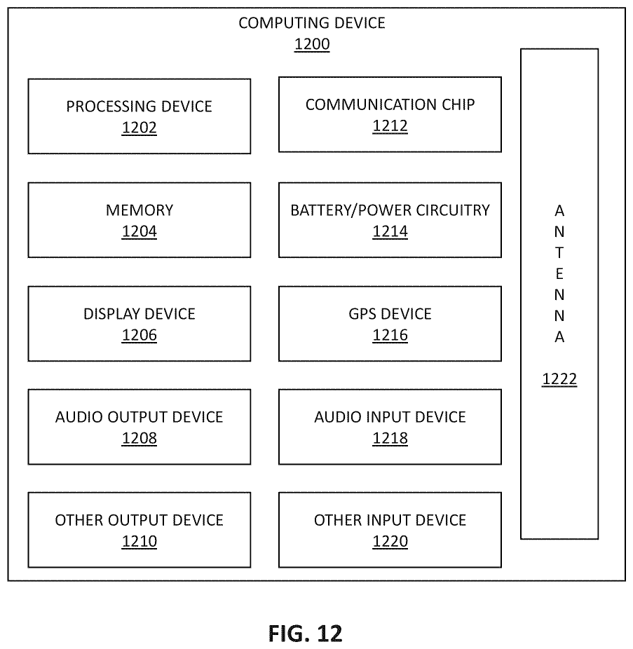

FIG. 2 is a block diagram of a DNN system 200, in accordance with various embodiments. The whole DNN system 200 or a part of the DNN system 200 may be implemented in one or more computing devices, such as the computing device 1200 in FIG. 12. The DNN system 200 can generate and execute DNNs, such as the DNN 100 in FIG. 1. As shown in FIG. 2, the DNN system 200 includes a DNN module 201 and a DNN accelerator 202. In other embodiments, alternative configurations, different or additional components may be included in the DNN system 200. For instance, the DNN system 200 may include multiple DNN modules or multiple DNN accelerators. Further, functionality attributed to a component of the DNN system 200 may be accomplished by a different component included in the DNN system 200 or a different system. In some embodiments, the DNN module 201 and DNN accelerator 202 may include different types of processing units. The DNN module 201 and DNN accelerator 202 may be implemented in the same chip or separate chips.

The DNN module 201 facilitates generation and application of DNNs. In some embodiments, the DNN module 201 may generate and train DNNs. For instance, the DNN module 201 can define the layered architecture of a DNN. The DNN module 201 can also determine the internal parameters of the DNN through a DNN training process. The DNN module 201 may also determine one or more hyperparameters that define how the DNN is trained. An example hyperparameter is a sparsity ratio that defines the sparsity level of one or more deep learning tensors for the DNN.

During or after the training process, the DNN module 201 may compress the DNN, e.g., by pruning internal parameters of the DNN. In some embodiments, the DNN module 201 may prune weights by using a block-wise pruning method. The DNN module 201 may select one or more blocks of weights of a deep learning operation in the DNN and change the values of the weights, which may be determined through the training process, to zero. A block of weights may include weights in a plurality of continuous input channels. The pruned weights may be skipped from computation to accelerate further training or inference of the DNN. As the pruned weights are zero valued, the sparsity acceleration would not impact the accuracy of the output of the DNN.

In some embodiments, the DNN module 201 may prune internal parameters to achieve a predetermined sparsity ratio. The sparsity ratio may be a ratio of the number of pruned weights to the total number of weights. In some embodiments, the DNN module 201 may determine the sparsity ratio based on the computation resources that are available for training or deploying the DNN, such as computation resources available in an edge device. Example computation resources include available data storage, bandwidth, processing capability, power, other types of computation resources, or some combination thereof. The DNN module 201 can compress the DNN to a size that is proper for the available computation resources. In some embodiments, after a DNN is trained or compressed, the DNN module 201 may validate the DNN before providing the DNN for use in a deep learning application.

In some embodiments, the DNN module 201 may generate a sparsity bitmap based on the weight pruning. For instance, the DNN module 201 may generate one or more sparsity bitmaps for a deep learning operation having one or more weight tensors. A sparsity bitmap may include one or more bits. A bit may correspond to one or more weights in the weight tensor(s) and indicate whether the one or more weights are zero valued or not. In an example, a bit of zero indicates that the one or more weights are zero valued, versus a bit of one indicates that the one or more weights are nonzero valued. The sparsity bitmap(s) may be used to accelerate computations in the deep learning operation. For instance, computations on weights corresponding to bits of zero in the sparsity bitmap(s) can be skipped.

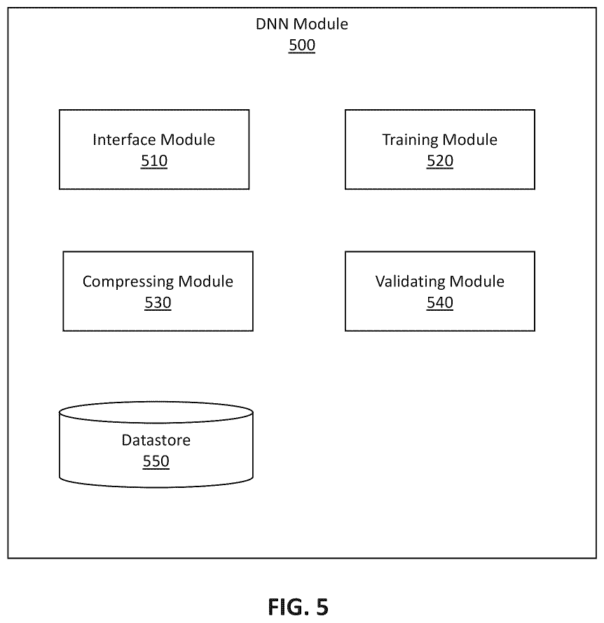

The DNN module 201 may further deploy trained, compressed, or validated DNNs for use in deep learning applications. In some embodiments, the DNN module 201 may distribute trained, compressed, or validated DNNs to devices or systems which may use the DNNs to perform tasks (e.g., image classification, motion planning, etc.) for which the DNNs were trained. In other embodiments, the DNN module 201 may facilitate deployment of the DNNs using the DNN accelerator 202. For instance, the DNN module 201 may receive data from a device or system coupled with the DNN system 200 and input the received data (or data generated by the DNN module 201, e.g., based on the received data) into a DNN. The DNN module 201 may generate instructions (e.g., configuration files) that control the operation of the DNN accelerator 202 during the DNN inference. The DNN module 201 may receive an output of the DNN from the DNN accelerator 202. The DNN module 201 may transmit the output of the DNN (or a result of processing the output of the DNN by the DNN module 201) to the device or system. Certain aspects of the DNN module 201 are provided below in conjunction with FIG. 5.

The DNN accelerator 202 executes DNNs provided by the DNN module 201. For instance, the DNN accelerator 202 can perform DNN inference, e.g., by running deep learning operations in the DNNs, for training DNNs or for using the trained/compressed/validated DNNs to perform tasks. As shown in FIG. 2, the DNN accelerator 202 includes a memory 210, a DMA (direct memory access) engine 220, and compute block 230 (individually referred to as “compute block 230”). In other embodiments, alternative configurations, different or additional components may be included in the DNN accelerator 202. For example, the DNN accelerator 202 may include more than one memory 210 or DMA engine 220. As another example, the DNN accelerator 202 may include a single compute block 230. Further, functionality attributed to a component of the DNN accelerator 202 may be accomplished by a different component included in the DNN accelerator 202 or by a different system. A component of the DNN accelerator 202 may be implemented in hardware, software, firmware, or some combination thereof.

The memory 210 stores data associated with deep learning operations (including activation functions) performed by the DNN accelerator. In some embodiments, the memory 210 may store data to be used by the compute blocks 230 for DNN inference. For example, the memory 210 may store data computed by the precompute module 205, such as coefficients of Taylor series. As another example, the memory 210 may store weights, such as weights of convolutional layers, which are determined by training DNNs. The memory 210 may also store data generated by the compute blocks 230 from performing deep learning operations in DNNs. Example deep learning operations include convolutions (also referred to as “convolutional operations”), pooling operations, elementwise operations, activation functions, other types of deep learning operations, or some combination thereof. The memory 210 may be a main memory of the DNN accelerator 202. In some embodiments, the memory 210 includes one or more DRAMs (dynamic random-access memory).

The DMA engine 220 facilitates data transfer between the memory 210 and local memories of the compute blocks 230. For example, the DMA engine 220 can read data from the memory 210 and write data into a local memory of a compute block 230. As another example, the DMA engine 220 can read data from a local memory of a compute block 230 and write data into the memory 210. The DMA engine 220 provides a DMA feature that allows the compute block 230 to initiate data transfer between the memory 210 and the local memories of the compute blocks 230 and to perform other operations while the data transfer is in being conducted. In some embodiments, the DMA engine 220 may read tensors from the memory 210, modify the tensors in a way that is optimized for the compute block 230 before it writes the tensors into the local memories of the compute blocks 230.

The compute blocks 230 can perform deep learning operations in DNNs. For instance, a compute block 230 may run a deep learning operation in a DNN layer, or a portion of the deep learning operation, at a time. The compute blocks 230 may be capable of running various types of deep learning operations, such as convolution, pooling, elementwise operation, linear operation, nonlinear operation, and so on. In an example, a compute block 230 may perform convolutions, e.g., standard convolution or depthwise convolution. In some embodiments, the compute block 230 receives an input tensor and one or more convolutional kernels and performs a convolution with the input tensor and convolutional kernels. The result of the convolution may be an output tensor, which can be further computed, e.g., by the compute block 230 or another compute block 230. In some embodiments, the operations of the DNN layers may be run by multiple compute blocks 230 in parallel. For instance, multiple compute blocks 230 may each perform a portion of a workload for a convolution. Data may be shared between the compute blocks 230. A compute block 230 may also be referred to as a compute tile. In some embodiments, each compute block 230 may be a processing unit.

In the embodiments of FIG. 2, each compute block 230 includes a local memory 240, a PE array 250, a data distributor 260, a sparsity accelerator 270, an ad a post processing unit 280. Some or all the components of the compute block 230 can be implemented on the same chip. In other embodiments, alternative configurations, different or additional components may be included in the compute block 230. Further, functionality attributed to a component of the compute block 230 may be accomplished by a different component included in the compute block 230, a different compute block 230, another component of the DNN accelerator 202, or a different system. A component of the compute block 230 may be implemented in hardware, software, firmware, or some combination thereof.

The local memory 240 is local to the corresponding compute block 230. In the embodiments of FIG. 2, the local memory 240 is inside the compute block 230. In other embodiments, the local memory 240 may be outside the compute block 230. The local memory 240 may store data received, used, or generated by the PE array 250 and the post processing unit 280, Examples of the data may include input activations, weights, output activations, coefficients of Taylor series, results of activation functions, sparsity bitmaps, and so on. Data in the local memory 240 may be transferred to or from the memory 210, e.g., through the DMA engine 220. In some embodiments, data in the local memory 240 may be transferred to or from the local memory of another compute block 230.

In some embodiments, the local memory 240 includes one or more static random-access memories (SRAMs). The local memory 240 may be byte-addressable, and each memory address identifies a single byte (eight bits) of storage. In some embodiments, the local memory 240 may include memory banks. The number of data banks in the local memory 240 may be 16, 64, 128, 256, 512, 1024, 2048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 240 in a single read cycle. In other embodiments, 16 bits can be transferred from the local memory 240 in multiple read cycles, such as two cycles.

The PE array 250 may include PEs arranged in columns, or columns and rows. Each PE can perform MAC operations. In some embodiments, a PE includes one or more multipliers for performing multiplications. An PE may also include one or more accumulators (“adders”) for performing accumulations. A column of PEs is referred to as a PE column. A PE column may be associated with one or more MAC lanes. A MAC lane is a path for loading data into a MAC column. A MAC lane may be also referred to as a data transmission lane or data loading lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 250 may be capable of depthwise convolution, standard convolution, or both. In a depthwise convolution, a PE may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 250 may output multiple output operands at a time, each of which is generated by a different PE, In a standard convolution, MAC operations may include accumulations across the channels. For instance, as opposed to generating an output operand, a PE may accumulate products across different channels to generate a single output point.

In some embodiments, the PE array 250 may perform MAC operations in quantized inference, such as MAC operations in a quantized convolution. In some embodiments, a PE in the PE array 250 may receive quantized activation and quantized weights and compute a quantized MAC result. The quantized MAC result may be a quantized value in an integer format and may be the output of the PE. In some embodiments, the PE may also include a quantization multiplier that can multiply a quantization scale with the quantized MAC result, and the output of the PE may be a real value in a floating-point format. The PE may include no quantization subtractors as zero-point offsetting is not needed for the MAC operations in quantized inference.

The data distributor 260 distributes data (e.g., input activations, weights, etc.) of deep learning operations to PEs in the PE array 250 for the PE array 250 to process the data to perform computations in the deep learning operations. The data may be stored in the local memory 240. In some embodiments, the data distributor 260 may be arranged on a data load path from the local memory 240 to the PE array 250.

In some embodiments, the data distributor 260 may distribute data of a deep learning operation to the PEs based on the structures of an input tensor (e.g., the input tensor 310) and one or more weight tensors (e.g., the filters 320) of the deep learning operation. For instance, the input tensor may include a plurality of input channels. A weight tensor may include weights in the input channels. In embodiments where the deep learning operation has multiple output channels (i.e., the output tensor (e.g., the output tensor 330) includes multiple channels), there would be multiple weight tensors, each of which is for one of the output channels. The data distributor 260 may distribute the data based on output channels. In an embodiment, the data distributor 260 may distribute the weight tensors to different PE columns. For instance, each PE column may receive a different weight tensor from the other PE columns. Each of the PE columns may receive the input tensor and perform MAC operations on the input tensor and the corresponding weight tensor.

For a single PE column, the data distributor 260 may partition the input tensor into input operands and partition the weight tensor into weight operands. The data distributor 260 may distribute an input operand (aka “activation operation,” e.g., the input operand 317) and a corresponding weight operand (e.g., the weight operand 327) to a PE in the PE column. The PE may perform a MAC operation on the input operand and weight operand. The data distributor 260 may distribute different input operands/weight operands to the same PE in different computation cycles. In some embodiments, an input operand may include input activations having the same (X, Y) coordinates but in different input channels. Similarly, a weight operand may include input weights having the same (X, Y) coordinates but in different input channels. In an example, an activation in the input operand may be in a different input channel from all the other activations in the input operand, and a weight in the weight operand may be in a different input channel from all the other weights in the weight operand.

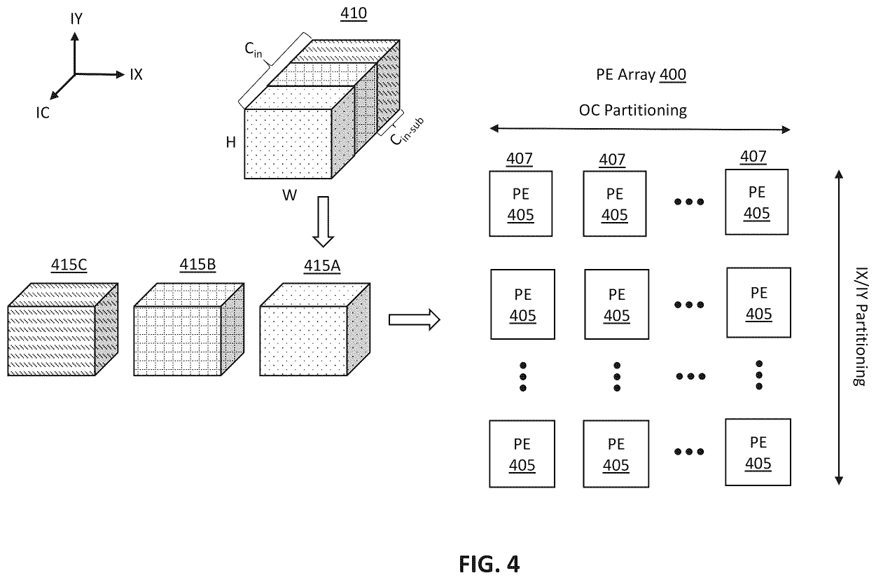

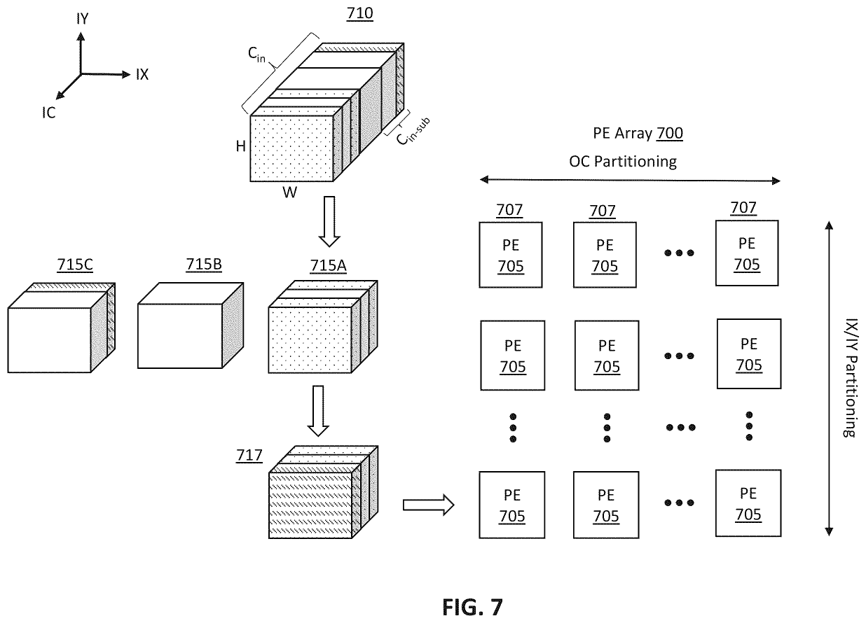

In some embodiments (e.g., embodiments where block-wise weight pruning has been done), the data distributor 260 may not distribute certain weights or activations to the PE array 250. For instance, the data distributor 260 may skip the blocks of pruned weights (and corresponding activations). More details regarding data distribution are provided below in conjunction with FIGS. 4 and 7.

The sparsity accelerator 270 accelerates computations in the PE array 250 based on sparsity in activations or weights. In some embodiments (e.g., embodiments where the compute block 230 executes a convolutional layer), a computation in a PE may be a MAC operation on an input operand and a weight operand. The input operand may include one or more activations in the input tensor of the convolution. Different activations may be in different input channels. The weight operand may include one or more weights in the filter of the convolution. The values of the weights are determined through training the DNN. The weights in the weight operand may be in different input channels.

In some embodiments, the input operand is associated with an activation bitmap, which may be stored in the local memory 240. The activation bitmap can indicate positions of the nonzero-valued activations in the input operand. The activation bitmap may include a plurality of bits, each of which corresponds to a respective activation in the input operand. The position of a bit in the activation bitmap may match the position of the corresponding activation in the input operand. A bit in the activation bitmap may be zero or one. A zero valued bit indicates that the value of the corresponding activation is zero, a one valued bit indicates that the value of the corresponding activation is nonzero. In some embodiments, the activation bitmap may be generated during the execution of another DNN layer, e.g., a layer that is arranged before the convolutional layer in the DNN.

In some embodiments, the weight operand is associated with a weight bitmap, which may be stored in the local memory 240. The weight bitmap can indicate positions of the nonzero-valued weights in the weight operand. The weight bitmap may include a plurality of bits, each of which corresponds to a respective weight in the weight operand. The position of a bit in the weight bitmap may match the position of the corresponding weight in the weight operand. A bit in the weight bitmap may be zero or one. A zero valued bit indicates that the value of the corresponding weight is zero, a one valued bit indicates that the value of the corresponding weight is nonzero.

In some embodiments, the sparsity accelerator 270 may receive the activation bitmap and the weight bitmap and generate a combined sparsity bitmap for the MAC operation to be performed by the PE. In some embodiments, the sparsity accelerator 270 generates the combined sparsity bitmap 735 by performing one or more AND operations on the activation bitmap and the weight bitmap. Each bit in the combined sparsity bitmap is a result of an AND operation on a bit in the activation bitmap and a bit in the weight bitmap, i.e., a product of the bit in the activation bitmap and the bit in the weight bitmap. The position of the bit in the combined sparsity bitmap matches the position of the bit in the activation bitmap and the position of the bit in the weight bitmap. A bit in the combined bitmap corresponds to a pair of activation and weight (activation-weight pair). A zero bit in the combined sparsity bitmap indicates that at least one of the activation and weight in the pair is zero. A one bit in the combined sparsity bitmap indicates that both the activation and weight in the pair are nonzero. The combined sparsity bitmap may be stored in the local memory 240.

The sparsity accelerator 270 may provide activations and weights to the PE based on the combined sparsity bitmap. For instance, the sparsity accelerator 270 may identify one or more nonzero-valued activation-weight pairs from the local memory 240 based on the combined sparsity bitmap. The local memory 240 may store input operands and weight operands in a compressed format so that nonzero-valued activations and nonzero-valued weights are stored but zero-valued activations and zero-valued weights are not stored. The nonzero-valued activation(s) of an input operand may constitute a compressed input operand. The nonzero-valued weight (s) of a weight operand may constitute a compressed weight operand. For a nonzero-valued activation-weight pair, the sparsity accelerator 270 may determine a position the activation in the compressed input operand and determine a position of the weight in the compressed weight operand based on the activation bitmap, weight bitmap, and the combined bitmap. The activation and weight can be read from the local memory 240 based on the positions determined by the sparsity accelerator 270.

In some embodiments, the sparsity accelerator 270 includes a sparsity acceleration logic that can compute position bitmaps based on the activation bitmap and weight bitmap. The sparsity accelerator 270 may determine position indexes of the activation and weight based on the position bitmaps. In an example, the position index of the activation in the compressed input operand may equal the number of one(s) in an activation position bitmap generated by the sparsity accelerator 270, and the position index of the weight in the compressed weight operand may equal the number of one(s) in a weight position bitmap generated by the sparsity accelerator 270. The position index of the activation or weight indicates the position of the activation or weight in the compressed input operand or the compressed weight operand. The sparsity accelerator 270 may read the activation and weight from one or more memories based on their position indexes.

The sparsity accelerator 270 can forward the identified nonzero-valued activation-weight pairs to the PE, The sparsity accelerator 270 may skip the other activations and the other weights, as they will not contribute to the result of the MAC operation. In some embodiments, the local memory 240 may store the nonzero-valued activations and weights and not store the zero-valued activations or weights. The nonzero-valued activations and weights may be loaded to one or more register files of the PE, from which the sparsity accelerator 270 may retrieve the activations and weights corresponding to the ones in the combined sparsity bitmap. In some embodiments, the total number of ones in the combined sparsity bitmap equals the total number of activation-weight pairs that will be computed by the PE, while the PE does not compute the other activation-weight pairs. By skipping the activation-weight pairs corresponding to zero bits in the combined sparsity bitmap, the computation of the PE will be faster, compared with the PE computing all the activation-weight pairs in the input operand and weight operand.

The sparsity accelerator 270 may be implemented in hardware, software, firmware, or some combination thereof. In some embodiments, at least part of the sparsity accelerator 270 may be inside a PE. Even though FIG. 4 shows a single sparsity accelerator 270, the compute block 230 may include multiple sparsity modules 450. In some embodiments, every PE in the PE array 250 is implemented with a sparsity accelerator 270 for accelerating computation and reducing power consumption in the individual PE. In other embodiments, a subset of the PE array 250 (e.g., a PE column or multiple PE columns in the PE array 250) may be implemented with a sparsity accelerator 270 for acceleration computations in the subset of PEs.

The post processing unit 280 processes outputs of the PE array 250. In some embodiments, the post processing unit 280 computes activation functions. The post processing unit 280 may receive outputs of the PE array 250 as inputs to the activation functions. The post processing unit 280 may transmit the outputs of the activation functions to the local memory 240. The outputs of the activation functions may be retrieved later by the PE array 250 from the local memory 240 for further computation. For instance, the post processing unit 280 may receive an output tensor of a DNN layer from the PE array 250 and computes one or more activation functions on the output tensor. The results of the computation by the post processing unit 280 may be stored in the local memory 240 and later used as input tensor of the next DNN layer. In addition or alternative to activation functions, the post processing unit 280 may perform other types of post processing on outputs of the PE array 250. For instance, the post processing unit 280 may apply a bias on an output of the PE array 250.

In some embodiments, the local memory 240 is associated with a load path and a drain path may be used for data transfer within the compute block 230. For instance, data may be transferred from the local memory 240 to the PE array 250 through the load path. Data may be transferred from the PE array 250 to the local memory 240 through the drain path. The data distributor 260 may be arranged on the load path. The post processing unit 280 may be arranged on the drain path for processing outputs of the PE array before the data is written into the local memory 240.

### Example Convolution

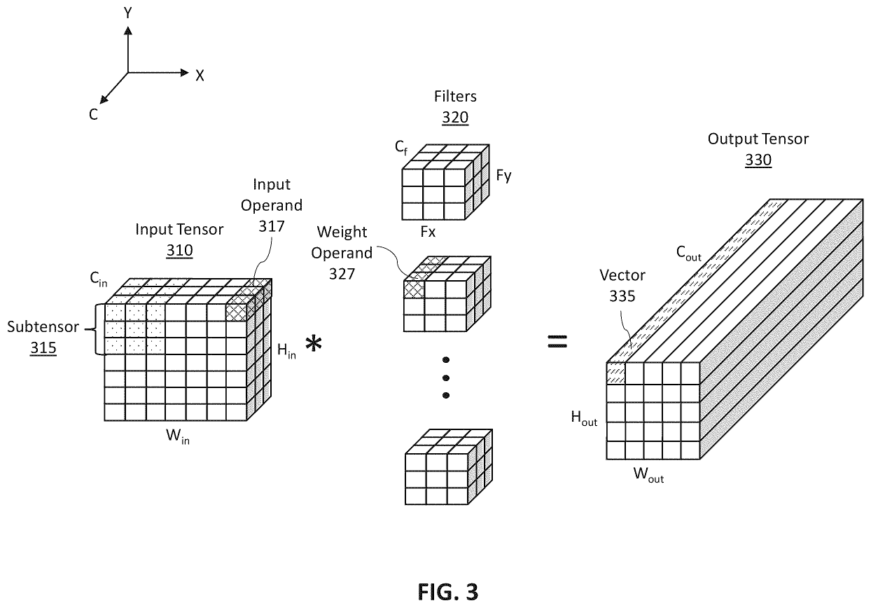

FIG. 3 illustrates an example convolution, in accordance with various embodiments. The convolution may be a convolution in a convolutional layer of a DNN, e.g., a convolutional layer 110 in FIG. 1. The convolution can be executed on an input tensor 310 and filters 320 (individually referred to as “filter 320”). The result of the convolution is an output tensor 330. In some embodiments, the convolution is performed by a DNN accelerator. An example of the DNN accelerator may be the DNN accelerator 202 in FIG. 2.

In the embodiments of FIG. 3, the input tensor 310 includes activations (also referred to as “input activations,” “elements,” or “input elements”) arranged in a 3D matrix. An input element is a data point in the input tensor 310. The input tensor 310 has a spatial size Hᵢₙ×Wᵢₙ×Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X axis, which indicates the number of activations in a row in the 3D matrix of each input channel), and Cᵢₙ is the depth of the 3D matrix (i.e., the length along the Z axis, which indicates the number of input channels). For purpose of simplicity and illustration, the input tensor 310 has a spatial size of 7×7×3, i.e., the input tensor 310 includes three input channels and each input channel has a 7×7 2D matrix. Each input element in the input tensor 310 may be represented by a (X, Y, Z) coordinate. In other embodiments, the height, width, or depth of the input tensor 310 may be different.

Each filter 320 includes weights arranged in a 3D matrix. The values of the weights may be determined through training the DNN. A filter 320 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 320 in FIG. 3 has a spatial size of 3×3×3, i.e., the filter 320 includes 3 convolutional kernels with a spatial size of 3×3 . In other embodiments, the height, width, or depth of the filter 320 may be different. The spatial size of the convolutional kernels is smaller than the spatial size of the 2D matrix of each input channel in the input tensor 310.

An activation or weight may take one or more bytes in a memory. The number of bytes for an activation or weight may depend on the data format. For example, when the activation or weight has a INT8 format, the activation takes one byte. When the activation or weight has a FP16 format, the activation or weight takes two bytes. Other data formats may be used for activations or weights.

In the convolution, each filter 320 slides across the input tensor 310 and generates a 2D matrix for an output channel in the output tensor 330. In the embodiments of FIG. 3, the 2D matrix has a spatial size of 5×5. The output tensor 330 includes activations (also referred to as “output activations,” “elements,” or “output element”) arranged in a 3D matrix. An output activation is a data point in the output tensor 330. The output tensor 330 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 3D matrix of each output channel), Wₒᵤₜ is the width of the 3D matrix (i.e., the length along the X axis, which indicates the number of output activations in a row in the 3D matrix of each output channel), and cut is the depth of the 3D matrix (i.e., the length along the Z axis, which indicates the number of output channels). Gut may equal the number of filters 320 in the convolution. Hₒᵤₜ and Wₒᵤₜ may depend on the heights and weights of the input tensor 310 and each filter 320.

As a part of the convolution, MAC operations can be performed on a 3×3×3 subtensor 315 (which is highlighted with a dotted pattern in FIG. 3) in the input tensor 310 and each filter 320. The result of the MAC operations on the subtensor 315 and one filter 320 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 315 and all the filters 320 are finished, a vector 335 is produced. The vector 335 is highlighted with slashes in FIG. 3. The vector 335 includes a sequence of output activations, which are arranged along the Z axis. The output activations in the vector 335 have the same (X, Y) coordinate, but the output activations correspond to different output channels and have different Z coordinates. The dimension of the vector 335 along the Z axis may equal the total number of output channels in the output tensor 330. After the vector 335 is produced, further MAC operations are performed to produce additional vectors till the output tensor 330 is produced.

In some embodiments, the MAC operations on a 3×3×3 subtensor (e.g., the subtensor 315) and a filter 320 may be performed by a plurality of PEs. One or more PEs may receive an input operand (e.g., an input operand 317 shown in FIG. 3) and a weight operand (e.g., the weight operand 327 shown in FIG. 3). The input operand 317 includes a sequence of activations having the same (x, y) coordinate but different z coordinates. The input operand 317 includes an activation from each of the input channels in the input tensor 310. The weight operand 327 includes a sequence of weights having the same (x, y) coordinate but different z coordinates. The weight operand 327 includes a weight from each of the channels in the filter 320.

Activations in the input operand 317 and weights in the weight operand 327 may be sequentially fed into a PE. The PE may receive an activation and a weight (“an activation-weight pair”) at a time and multiple the activation and the weight. The position of the activation in the input operand 317 may match the position of the weight in the weight operand 327. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 330 may be further processed based on one or more activation functions before they are stored or inputted into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the input tensor 310 may be results of post processing of the previous DNN layer.

### Example Data Distribution

FIG. 4 illustrates data distribution to PEs 405 in a PE array 400 for a deep learning operation, in accordance with various embodiments. An example of the deep learning operation may be the convolution illustrated in FIG. 3. For the purpose of illustration, FIG. 4 shows distribution of data in a tensor 410. The tensor 410 may be a weight tensor. The tensor 410 may be generated by training a DNN including the deep learning operation. The tensor 410 has three dimensions along the IX, IY, and IC axes, respectively. The IC axis corresponds to the input channels of the deep learning operation. In the embodiment of FIG. 4, the tensor 410 has a spatial size of H×W×Cᵢₙ, where Cᵢₙ denotes the length of the tensor 410 along the IC axis, which may equal the number of input channels of the deep learning operation. In some embodiments, the tensor 410 may be across multiple output channels of the deep learning operation.

As shown in FIG. 4, the tensor 410 is divided into three tensors 415A-415C (collectively referred to as “tensors 415” or “tensor 415”). Each tensor 415 is a portion of the tensor 410. A tensor 415 includes a subset of the input channels of the deep learning operation. In the embodiments of FIG. 4, a tensor 415 has a spatial size of H×W×C_{in-sub}. The tensor 415 has the same dimensions as the tensor 410 along the IX and IY axes but has a smaller dimension along the IC axis than the tensor 410. C_{in-sub} denotes the number of input channels in the tensor 415 and may equal Cᵢₙ divided by three. In other embodiments, a tensor 415 may have a different shape or size from the shape or size shown in FIG. 4. Also, the tensor 410 may be divided into a different number of tensors.

The tensor 410 is to be processed by the PE array 400 for performing the deep learning operation. The PEs 405 (individually referred to as “PE 405”) in the PE array 400 are arranged in PE columns 407 (individually referred to as “PE column 407”). Each PE column 407 includes a subset of the PEs 405. In some embodiments, the PE columns 407 includes the same number of PEs 405. The PE array 400 may be an embodiment of the PE array 250 in FIG. 2. In some embodiments, the tensor 410 may be divided for the reason that the tensor 410 is too large for the PE array 400 to process in one computation round.

The tensors 415 may be sequentially fed into the PE array 400 for computation. For instance, the tensor 415A is fed into the PE array 400 for a first round of computation by the PE array 400, the tensor 415B is fed into the PE array 400 for a second round of computation by the PE array 400, and the tensor 415C is fed into the PE array 400 for a third round of computation by the PE array 400.

The data elements in a tensor 415 may be distributed to some or all PEs 405 in a PE column 407 of the PE array 400. Other PE columns 407 may receive other tensors. In the embodiments of FIG. 4, the data elements in the tensor 415 are first distributed based on the output channels. A single PE column 407 receives data elements corresponding to the same output channel. Within the PE column 407, different PEs 405 receive data elements corresponding to different (X,Y) coordinates. In some embodiments, the same PE 405 may receive data elements having the same (X,Y) coordinates but in different input channels. The PE 405 may perform computations (e.g., MAC operation) on the data elements.

### Example DNN Module

FIG. 5 is a block diagram of a DNN module 500, in accordance with various embodiments. The DNN module 500 may be an embodiment of the DNN module 201 in FIG. 2. As shown in FIG. 5, the DNN module 500 includes an interface module 510, a training module 520, a compressing module 530, a validating module 540, and a datastore 550. In other embodiments, alternative configurations, different or additional components may be included in the DNN module 500. Further, functionality attributed to a component of the DNN module 500 may be accomplished by a different component included in the DNN module 500 or a different module or system.

The interface module 510 facilitates communications of the DNN module 500 with other modules or systems. For example, the interface module 510 establishes communications between the DNN module 500 with an external database to receive data that can be used to train DNNs or input into DNNs to perform tasks. As another example, the interface module 510 supports the DNN module 500 to distribute DNNs to other systems, e.g., computing devices configured to apply DNNs to perform tasks.

The training module 520 trains DNNs by using a training dataset. The training module 520 forms the training dataset. In an embodiment where the training module 520 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validating module 540 to validate performance of a trained DNN. The portion of the training dataset not including the tuning subset and the validation subset may be used to train the DNN.

The training module 520 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 5, 50, 500, 500, or even larger.

The training module 520 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different category by training.

In the process of defining the architecture of the DNN, the training module 520 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 520 defines the architecture of the DNN, the training module 520 inputs a training dataset into the DNN. The training dataset includes a plurality of training samples. An example of a training sample includes an object in an image and a ground-truth label of the object. The training module 520 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 520 uses a cost function to minimize the error.

The training module 520 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 520 finishes the predetermined number of epochs, the training module 520 may stop updating the parameters in the DNN. The DNN having the updated parameters is referred to as a trained DNN.

The compressing module 530 compresses DNNs, e.g., by pruning weights in the DNNs. In some embodiments, the compressing module 530 may prune weights in DNNs using a block-wise pruning approach. The compressing module 530 may identify one or more blocks of weights (“weight blocks”) in a weight tensor of a deep learning operation and prune all the weights in the identified block(s). A weight block may be a subtensor in the weight tensor and includes weights in a certain number of input channels. The weight tensor may be a filter. The weight tensor may correspond to an output channel. For instance, all the weights in the weight tensor may be for the same output channel. The deep learning operation may have multiple weight tensors for different output channels.

The compressing module 530 may determine which weight block(s) to prune based on a sparsity ratio, values of the weights, a desirable accuracy of the deep learning operation or DNN, one or more attributes of the DNN accelerator that trains or deploys the DNN, other factors, or some combination thereof. For instance, the pruning process by the compressing module 530 can be hardware aware, and the compressing module 530 may determine how many weight blocks to prune for a single output channel or multiple output channels based on an attribute of internal register files (e.g., the input register files 1010, the weight register files 1020, etc.) of the DNN accelerator, PE arrangement in a PE array of the DNN accelerator, or other attributes of the DNN accelerator. The attribute of register files may be the granularity at which the register files hold data, such as the number of channels or operands that can be loaded to the register files for a single context in a single load round.

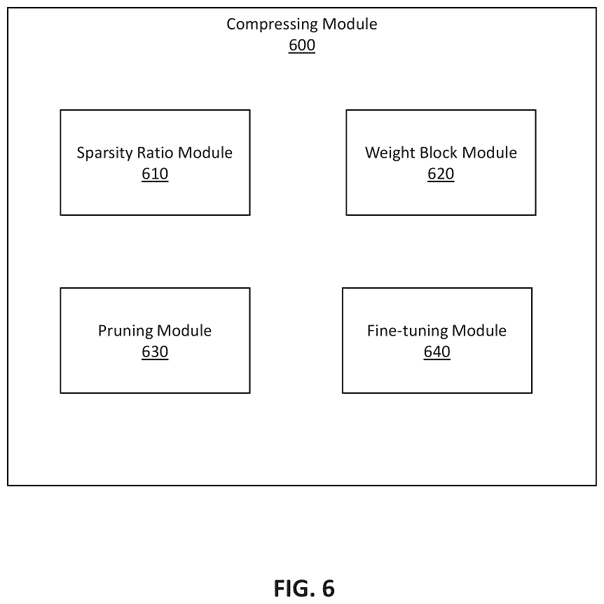

After the block-wise pruning process, the compressing module 530 may fine tune the DNN, e.g., through a re-training process. In some cases, the compressing module 530 can achieve a desirable sparsity ratio with a relatively small number of epochs for re-training, making it a more time-efficient approach for deployment compared to currently available pruning approaches. Also, the block-wise weight pruning approach may require minimal or even no hardware changes and can result in significant power and memory bandwidth savings across various data-paths of the DNN accelerator. The block-wise weight pruning approach can also reduce the overall sparsity bitmap footprint since it tracks weight blocks rather than individual weights that can lead to CK factor of sparsity bandwidth/storage savings for weights where C and K are the IC (input channel) and OC (output channel) block granularities. Certain aspects of the compressing module 530 are described below in conjunction with FIG. 6.

The validating module 540 verifies accuracy of trained or compressed DNNs. In some embodiments, the validating module 540 inputs samples in a validation dataset into a trained DNN and uses the outputs of the DNN to determine the model accuracy. In some embodiments, a validation dataset may be formed of some or all the samples in the training dataset, Additionally or alternatively, the validation dataset includes additional samples, other than those in the training sets. In some embodiments, the validating module 540 may determine an accuracy score measuring the precision, recall, or a combination of precision and recall of the DNN. The validating module 540 may use the following metrics to determine the accuracy score: Precision=TP(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P +R)) unifies precision and recall into a single measure.

The validating module 540 may compare the accuracy score with a threshold score. In an example where the validating module 540 determines that the accuracy score of the augmented model is less than the threshold score, the validating module 540 instructs the training module 520 to re-train the DNN. In one embodiment, the training module 520 may iteratively re-train the DNN until the occurrence of a stopping condition, such as the accuracy measurement indication that the DNN may be sufficiently accurate, or a number of training rounds having taken place.

The datastore 550 stores data received, generated, used, or otherwise associated with the DNN module 500. For example, the datastore 550 stores the datasets used by the training module 520 and validating module 540. The datastore 550 may also store data generated by the training module 520 and validating module 540, such as the hyperparameters for training DNNs, internal parameters of trained DNNs (e.g., weights, etc.), data for sparsity acceleration (e.g., sparsity bitmap, etc.), and so on. In the embodiment of FIG. 5, the datastore 550 is a component of the DNN module 500. In other embodiments, the datastore 550 may be external to the DNN module 500 and communicate with the DNN module 500 through a network.

FIG. 6 is a block diagram of a compressing module 600, in accordance with various embodiments. The compressing module 600 may be an embodiment of the compressing module 530 in FIG. 5. As shown in FIG. 6, the pruning module 600 includes a sparsity ratio module 610, a weight block module 620, a pruning module 630, and a fine-tuning module 640. In other embodiments, alternative configurations, different or additional components may be included in the compressing module 600. Further, functionality attributed to a component of the compressing module 600 may be accomplished by a different component included in the compressing module 600, the DNN module 500, or a different module or system.

The sparsity ratio module 610 determines sparsity ratios. A sparsity ratio may be for a particular deep learning operation. For instance, the sparsity ratio module 610 determine a sparsity ratio for a convolution. The sparsity ratio may measure the sparsity of weights of the deep learning operation after the weights pruned by the compressing module 600. The sparsity ratio may be a ratio of the number of to-be-pruned weights to the total number of weights of the deep learning operation.

In some embodiments, the sparsity ratio module 610 may determine a sparsity ratio based on a target accuracy of outputs of the corresponding deep learning operation or the DNN. Additionally or alternatively, the sparsity ratio module 610 may determine a sparsity ratio based on resources available for running the corresponding deep learning operation or the DNN. The resources may include data storage resources, computing resources, data transfer resources, time, power, and so on. Sparsity ratios may have various formats, such as percentage (e.g., 10%, 20%, 40%, etc.), fraction (e.g., ⅕, ¼, ⅓, etc.) N:M format (where N or M may be an integer), or other formats. In other embodiments, the sparsity ratio module 610 may receive the sparsity ratio from another module or system.

The weight block module 620 forms weight blocks. The weight block module 620 may form a plurality of weight blocks for a deep learning operation. A weight block is a tensor comprising a plurality of weights corresponding to one or more input channels of a deep learning operation. The weight block may be a subtensor, e.g., part of a weight tensor of the deep learning operation. In some embodiments, the weight block module 620 may partition a weight tensor of a deep learning operation into a plurality of subtensors by grouping input channels. For instance, the weight block module 620 may select some of the input channels of the deep learning operation and group the weights in the selected input channels into a weight block. The selected input channels in a weight block may be consecutive, e.g., the selected input channels are arranged consecutively in the weight tensor or input tensor.

In some embodiments, the weight block module 620 may determine the number of input channels in a weight block. For instance, the weight block module 620 may determine the number based on a target or desirable accuracy of the deep learning operation or the DNN. In some embodiments, the higher the accuracy is, the smaller the number is. In an example, the number of input channels in a weight block may be 4, 8, 16, or other numbers. In some embodiments, the weight block module 620 may partition the weight tensor into weight blocks having the same number of input channels. The dimensions of the weight blocks along the input channel axis may be the same. In some embodiments, the weight blocks may have the same dimension along the X or Y axis. In an embodiment, the weight block module 620 may partition the weight tensor into weight blocks having the same shape or spatial size.

The weight tensor may correspond to an output channel. The deep learning operation may have one or more other weight tensors corresponding to one or more other output channels. In some embodiments, the weight block module 620 may partition each of the weight tensors for different output channels. The partition of a weight tensor may be separate from the partition of another weight tensor. In some embodiments, the weight blocks for an output channel may have the same number of input channels as the weight blocks for another output channel. In an embodiment, the weight blocks for an output channel may have the same shape or spatial size as the weight blocks for another output channel.

The pruning module 630 selects one or more weight blocks generated by the weight block module 620 and prunes the selected weight blocks. In some embodiments, the pruning module 630 selects one or more weight blocks based on the norms of the weight blocks generated by the weight block module 620. A norm may be a function for a real or complex vector space to the non-negative real numbers in behaves in certain ways like the distance from the origin. The pruning module 630 may use L1 norms, L2 norms, and so on. The L1 norm of a weight block may be denoted as:

where x₁ . . . xₙ are weights in the weight block, n is an integer equal to the number of weights in the weight block. In some embodiments (e.g., embodiments where L2 norm is used), the pruning module 630 may compute x₁²+ . . . +xₙ² in lieu of \sqrt{x₁²+ . . . +xₙ²}.

The pruning module 630 may rank the weight blocks based on their norms and select one or more weight blocks based on the ranking. In an example, the pruning module 630 may select one or more weight blocks that have one or more smaller norms than the other weight blocks. After selecting the one or more weight blocks, the pruning module 630 may prune the weights in the one or more weight blocks, i.e., change the values of the weights to zero.

In some embodiments, the pruning module 630 may determine how many weight blocks to prune based on the sparsity ratio. For instance, the number of selected weight block(s) may equal the total number of weight blocks multiplied by the sparsity ratio. In addition or alternative to the sparsity ratio, the pruning module 630 may determine how many weight blocks to prune based on one or more attributes of the DNN accelerator that trains or executes the DNN. For instance, the pruning module 630 may determine how many weight blocks to prune based on a storage granularity of one or more register files associated with one or more PEs in the DNN accelerator. In an example, a register file may store up to 32 bytes per context per load round and the number of input channels in a weight block is 8, the pruning module 630 may determine that the number of weight blocks to prune is a multiple of 4.

In embodiments where the deep learning operations have weight tensors for multiple output channels, the pruning module 630 may prune each weight tensor separately. For instance, the pruning module 630 may rank the weight blocks of a weight tensor for a single output channel and select one or more weight blocks to prune for the output channel. The pruned weight blocks for different output channels may correspond to different input channels. In an example, weights in the first N input channels may be pruned for an output channel but not pruned for another output channel, where N is the number of input channels in a weight block. In some embodiments, the pruning module 630 may prune the same number of weight blocks for different output channels. For instance, in an example where the weights are distributed to different PE columns based on their output channels, the workload of the PE columns can be reduced evenly as the PE columns can avoid computations for the same number of weights.

The fine-tuning module 640 fine tunes DNNs after weights are pruned. In some embodiments, the fine-tuning process is a re-training or further training process. For instance, after weights in a DNN are pruned, the fine-tuning module 640 may further train the DNN by inputting a training dataset into the DNN. The values of the unpruned weights in the DNN may be modified based on outputs of the DNN and ground-truth labels of the training samples in the training dataset. In some embodiments, the values of the pruned weights (i.e., zero) are not changed during the fine-tuning process. For instance, the fine-tuning module 640 may place a mask over a pruned weight block and the mask can prevent values in the pruned weight blocks from being changed during the fine-tuning process. In other embodiments, the values of all weights, including the pruned weights, may be changed during the fine-tuning process. After one or more cycles of retraining and weight changing by the fine-tuning module 640, the pruning module 630 may perform a new pruning process, e.g., by selecting weight blocks and pruning the selected weight blocks. In some embodiments, the weight pruning process may be repeated multiple times before the fine-tuning process is done.

In some embodiments, the number of epochs in the fine-tuning process may be different from the number of epochs in the training process in which the pre-pruning values of the weights are determined. For instance, the fine-tuning process may have less epochs than the training process. In an example, the number of epochs in the fine-tuning process may be relatively small, such as 2, 3, 4, 5, etc.

FIG. 7 illustrates data distribution with increased weight sparsity, in accordance with various embodiments. FIG. 7 shows distribution of data in a tensor 710 to PEs 705 in a PE array 700. The tensor 710 may be a weight tensor. The tensor 710 has three dimensions along the IX, IY, and IC axes, respectively. The IC axis corresponds to the input channels of the deep learning operation. In the embodiment of FIG. 7, the tensor 710 has a spatial size of H×W×Cᵢₙ, where Cᵢₙ denotes the length of the tensor 710 along the IC axis, which may equal the number of input channels of the deep learning operation. In some embodiments, the tensor 710 may be across multiple output channels of the deep learning operation.

As shown in FIG, 7, the tensor 710 is divided into three tensors 715A-415C (collectively referred to as “tensors 715” or “tensor 715”). Each tensor 715 is a portion of the tensor 710. A tensor 715 includes a subset of the input channels of the deep learning operation. In the embodiments of FIG. 7, a tensor 715 has a spatial size of H×W×C_{in-sub}. The tensor 715 has the same dimensions as the tensor 710 along the IX and IY axes but has a smaller dimension along the IC axis than the tensor 710. C_{in-sub} denotes the number of input channels in the tensor 715 and may equal Cᵢₙ divided by three. In other embodiments, a tensor 715 may have a different shape or size from the shape or size shown in FIG. 7. Also, the tensor 710 may be divided into a different number of tensors.

The tensor 710 is to be processed by the PE array 700 for performing the deep learning operation. The PEs 705 (individually referred to as “PE 705”) in the PE array 700 are arranged in PE columns 707 (individually referred to as “PE column 707”). Each PE column 707 includes a subset of the PEs 705. The tensor 710 may be processed by some or all PEs 705 in a PE column 707. Other PE columns 707 may process other tensors. In some embodiments, the PE columns 707 includes the same number of PEs 705. The PE array 700 may be an embodiment of the PE array 250 in FIG. 2. In some embodiments, the tensor 710 may be divided for the reason that the tensor 710 is too large for the PE array 700 to process in one computation round.

Compared with the tensor 410 in FIG. 4, the tensor 710 in FIG. 7 has a higher sparsity level, i.e., a higher percentage of weights in the tensor 710 are zero valued. The tensor 710 may be generated from the tensor 410 through a block-wise weight pruning process. In FIG. 7, pruned portions of the tensor 710 are represented by white cuboids. As shown in FIG. 7, a portion of the tensor 715A is pruned, the entire tensor 715B is pruned, and a portion of the tensor 715C is pruned. The PE array 700 can skip computations of the pruned weights, as the zero-valued weights would have no impact on the result of the deep learning operation.

A dense tensor 717, which is smaller than the tensor 410 or 710, may be processed by the PE array 700. The dense tensor 717 includes the weights in the tensor 710 that are not pruned, i.e., unpruned weights. In embodiments where the tensor 410 requires three computation rounds, the tensor 710 may be processed using two rounds or even one round, during which the data in the dense tensor 717 is processed by the PE array and the other data in the tensor 710 are omitted from computation. Thus, the weight pruning can improve computation efficiency and save computation resources.

The tensor 710 and dense tensor 717 may correspond to a single output channel. The data elements in the dense tensor 717 may be distributed to some or all PEs 705 in a single PE column 707. In some embodiments (e.g., embodiments where the deep learning operation has multiple output channels), there may be multiple tensors, each of which corresponds to a different output channel. A dense tensor may be generated from each of the tensors. Each of the dense tensors may be processed by a different PE column 707. In some embodiments, the spatial size of dense tensors for different output channels may be the same (so the dense tensors have the same number of unpruned weights) so that the workload of the PE columns 707 are balanced. Within a single PE column 707, different PEs 705 may receive data elements corresponding to different (X,Y) coordinates. In some embodiments, the same PE 705 may receive data elements having the same (X,Y) coordinates but in different input channels. The PE 705 may perform computations (e.g., MAC operation) on the data elements.

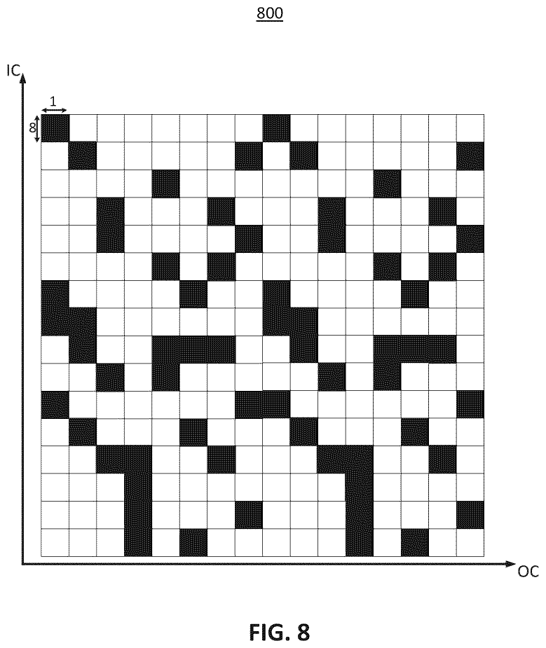

FIG. 8 illustrates an example sparsity map 800, in accordance with various embodiments. The sparsity map shows sparsity in the weights for a deep learning operation, e.g., a convolution. The horizontal axis denotes the output channels (represented by OC in FIG. 8) of the deep learning operation. The vertical axis denotes the input channels (represented by IC in FIG. 8) of the deep learning operation. For the purpose of illustration, the deep learning operation in FIG. 8 has 16 output channels and 128 input channels. In other embodiments, a deep learning operation may have a different number of output channels or input channels.

A subset of the weights in the deep learning operation are pruned using a block-wise pruning approach. Each cube in FIG. 8 represents a weight block that includes wights in 8 input channels and 1 output channel. The black cubes represent weight blocks that are pruned, and the white bules represent unpruned weight blocks.

As shown in FIG. 8, different output channels have the same number of pruned weight blocks, i.e., each output channel has four pruned weight blocks. In some embodiments, the number of pruned weight blocks in each output channel is determined based on a sparsity ratio. The sparsity ratio in the embodiments of FIG. 8 is 25%, i.e., 25% of all the weight blocks in each output channel should be pruned. The weights in different output channels may be processed by different PE columns, As the sparsity ratios of the output channels are the same, the reduction of the workloads of the PE columns can be even.

The positions of the pruned weight blocks in the sparsity map 800 are different for different output channels, indicating that for different output channels, weights in different input channels may be pruned. Even though the sparsity ratio in the embodiments of FIG. 8 is 25%, the sparsity ratio for the deep learning operation may be other numbers in other embodiments. Also, a weight block may include a different number of input channels.

### Example PE Array

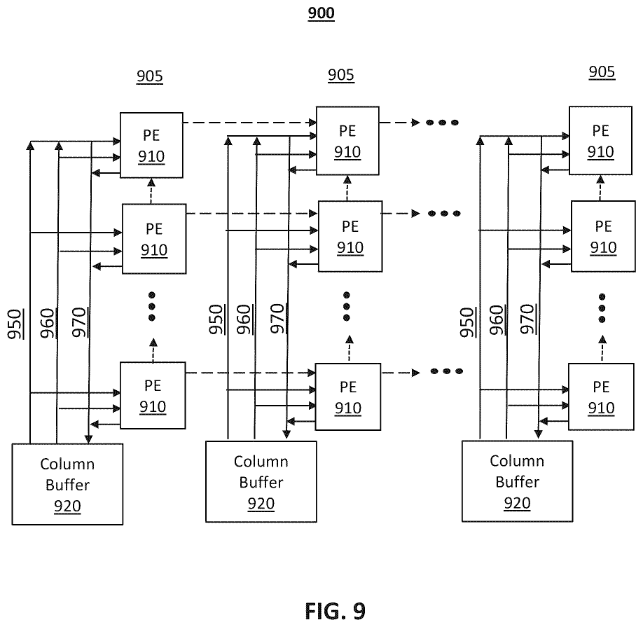

FIG. 9 illustrates an example PE array, in accordance with various embodiments. The PE array 900 may be an embodiment of the PE array 250 in FIG. 3. The PE array 900 includes a plurality of PEs 910 (individually referred to as “PE 910”). The PEs 910 can perform MAC operations, including MAC operations in quantized inference. The PEs 910 may also be referred to as neurons in the DNN. Each PE 910 has two input signals 950 and 960 and an output signal 970. The input signal 950 is at least a portion of an IFM to the layer. The input signal 960 is at least a portion of a filter of the layer. In some embodiments, the input signal 950 of a PE 910 includes one or more input operands, and the input signal 960 includes one or more weight operands.

Each PE 910 performs an MAC operation on the input signals 950 and 960 and outputs the output signal 970, which is a result of the MAC operation. Some or all of the input signals 950 and 960 and the output signal 970 may be in an integer format, such as INT8, or floating-point format, such as FP16 or BF16. For the purpose of simplicity and illustration, the input signals and output signal of all the PEs 910 have the same reference numbers, but the PEs 910 may receive different input signals and output different output signals from each other. Also, a PE 910 may be different from another PE 910, e.g., including more, fewer, or different components.

As shown in FIG. 9, the PEs 910 are connected to each other, as indicated by the dash arrows in FIG. 9. The output signal 970 of an PE 910 may be sent to many other PEs 910 (and possibly back to itself) as input signals via the interconnections between PEs 910. In some embodiments, the output signal 970 of an PE 910 may incorporate the output signals of one or more other PEs 910 through an accumulate operation of the PE 910 and generates an internal partial sum of the PE array.

In the embodiments of FIG. 9, the PEs 910 are arranged into columns 905 (individually referred to as “column 905”). The input and weights of the layer may be distributed to the PEs 910 based on the columns 905. Each column 905 has a column buffer 920. The column buffer 920 stores data provided to the PEs 910 in the column 905 for a short amount of time. The column buffer 920 may also store data output by the last PE 910 in the column 905. The output of the last PE 910 may be a sum of the MAC operations of all the PEs 910 in the column 905, which is a column-level internal partial sum of the PE array 900. In other embodiments, input and weights may be distributed to the PEs 910 based on rows in the PE array 900. The PE array 900 may include row buffers in lieu of column buffers 920. A row buffer may store input signals of the PEs in the corresponding row and may also store a row-level internal partial sum of the PE array 900.

In some embodiments, a column buffer 920 may be a portion of the local memory 240 in FIG. 3. The column buffer 920 may be associated with upper memory hierarchies, e.g., the memory 210 in FIG. 3. Data in the column buffer 920 may be sent to the upper memory hierarchies. The column buffer 920 may receive data from the upper memory hierarchies.

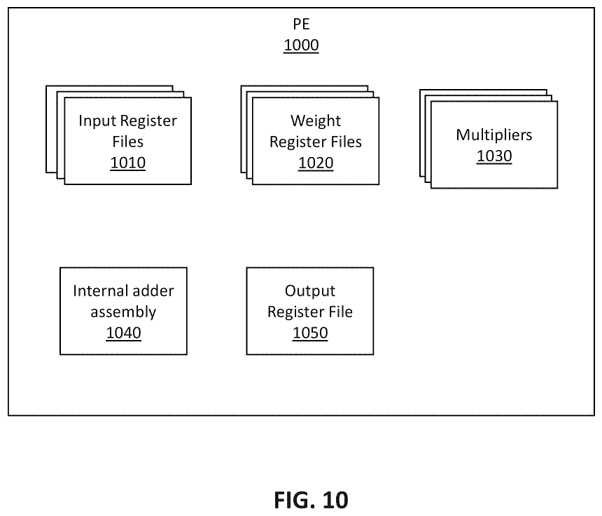

FIG. 10 is a block diagram of a PE 1000, in accordance with various embodiments. The PE 1000 may be an embodiment of the PE 910 in FIG. 9. The PE 1000 may perform MAC operations, e.g., MAC operations using data in integer formats. The PE 1000 may be an example PE in the PE array 250 described above in conjunction with FIG. 3. As shown in FIG. 10, the PE 1000 includes input register files 1010 (individually referred to as “input register file 1010”), weight registers file 1020 (individually referred to as “weight register file 1020”), multipliers 1030 (individually referred to as “multiplier 1030”), an internal adder assembly 1040, and an output register file 1050. In other embodiments, the PE 1000 may include fewer, more, or different components. For example, the PE 1000 may include multiple output register files 1050. As another example, the PE 1000 may include a single input register file 1010, weight register file 1020, or multiplier 1030. As yet another example, the PE 1000 may include an adder in lieu of the internal adder assembly 1040.

The input register files 1010 temporarily store input operands for MAC operations by the PE 1000. In some embodiments, an input register file 1010 may store a single input operand at a time. In other embodiments, an input register file 1010 may store multiple input operand or a portion of an input operand at a time. An input operand includes a plurality of input elements (i.e., input elements) in an input tensor. The input elements of an input operand may be stored sequentially in the input register file 1010 so the input elements can be processed sequentially. In some embodiments, each input element in the input operand may be from a different input channel of the input tensor. The input operand may include an input element from each of the input channels of the input tensor, and the number of input elements in an input operand may equal the number of the input channels. The input elements in an input operand may have the same (X,Y) coordinates, which may be used as the XY coordinates of the input operand. For instance, all the input elements of an input operand may be X0Y0, X0Y1, X1Y1, etc.

The weight register file 1020 temporarily stores weight operands for MAC operations by the PE 1000. The weight operands include weights in the filters of the DNN layer. In some embodiments, the weight register file 1020 may store a single weight operand at a time. other embodiments, an input register file 1010 may store multiple weight operands or a portion of a weight operand at a time. A weight operand may include a plurality of weights. The weights of a weight operand may be stored sequentially in the weight register file 1020 so the weight can be processed sequentially. In some embodiments, for a multiplication operation that involves a weight operand and an input operand, each weight in the weight operand may correspond to an input element of the input operand. The number of weights in the weight operand may equal the number of the input elements in the input operand.

In some embodiments, a weight register file 1020 may be the same or similar as an input register file 1010, e.g., having the same size, etc. The PE 1000 may include a plurality of register files, some of which are designated as the input register files 1010 for storing input operands, some of which are designated as the weight register files 1020 for storing weight operands, and some of which are designated as the output register file 1050 for storing output operands. In other embodiments, register files in the PE 1000 may be designated for other purposes, e.g., for storing scale operands used in elementwise add operations, etc.

The multipliers 1030 perform multiplication operations on input operands and weight operands. A multiplier 1030 may perform a sequence of multiplication operations on a single input operand and a single weight operand and generate a product operand including a sequence of products. Each multiplication operation in the sequence includes multiplying an input element in the input operand and a weight in the weight operand. In some embodiments, a position (or index) of the input element in the input operand matches the position (or index) of the weight in the weight operand. For instance, the first multiplication operation is a multiplication of the first input element in the input operand and the first weight in the weight operand, the second multiplication operation is a multiplication of the second input element in the input operand and the second weight in the weight operand, the third multiplication operation is a multiplication of the third input element in the input operand and the third weight in the weight operand, and so on. The input element and weight in the same multiplication operation may correspond to the same depthwise channel, and their product may also correspond to the same depthwise channel.

Multiple multipliers 1030 may perform multiplication operations simultaneously. These multiplication operations may be referred to as a round of multiplication operations. In a round of multiplication operations by the multipliers 1030, each of the multipliers 1030 may use a different input operand and a different weight operand. The different input operands or weight operands may be stored in different register files of the PE 1000. For instance, a first multiplier 1030 uses a first input operand (e.g., stored in a first input register file 1010) and a first weight operand (e.g., stored in a first weight register file 1020), versus a second multiplier 1030 uses a second input operand (e.g., stored in a second input register file 1010) and a second weight operand (e.g., stored in a second weight register file 1020), a third multiplier 1030 uses a third input operand (e.g., stored in a third input register file 1010) and a third weight operand (e.g., stored in a third weight register file 1020), and so on. For an individual multiplier 1030, the round of multiplication operations may include a plurality of cycles. A cycle includes a multiplication operation on an input element and a weight.

The multipliers 1030 may perform multiple rounds of multiplication operations. A multiplier 1030 may use the same weight operand but different input operands in different rounds. For instance, the multiplier 1030 performs a sequence of multiplication operations on a first input operand stored in a first input register file in a first round, versus a second input operand stored in a second input register file in a second round. In the second round, a different multiplier 1030 may use the first input operand and a different weight operand to perform another sequence of multiplication operations. That way, the first input operand is reused in the second round. The first input operand may be further reused in additional rounds, e.g., by additional multipliers 1030.

The internal adder assembly 1040 includes one or more adders inside the PE 1000, i.e., internal adders. The internal adder assembly 1040 may perform accumulation operations on two or more products operands from multipliers 1030 and produce an output operand of the PE 1000. In some embodiments, the internal adders are arranged in a sequence of tiers. A tier includes one or more internal adders. For the first tier of the internal adder assembly 1040, an internal adder may receive product operands from two or more multipliers 1030 and generate a sum operand through a sequence of accumulation operations. Each accumulation operation produces a sum of two or more products, each of which is from a different multiplier 1030. The sum operand includes a sequence of sums, each of which is a result of an accumulation operation and corresponds to a depthwise channel. For the other tier(s) of the internal adder assembly 1040, an internal adder in a tier receives sum operands from the precedent tier in the sequence. Each of these numbers may be generated by a different internal adder in the precedent tier. A ratio of the number of internal adders in a tier to the number of internal adders in a subsequent tier may be 2:1. In some embodiments, the last tier of the internal adder assembly 1040 may include a single internal adder, which produces the output operand of the PE 1000.

The output register file 1050 stores output operands of the PE 1000. In some embodiments, the output register file 1050 may store an output operand at a time. In other embodiments, the output register file 1050 may store multiple output operands or a portion of an output operand at a time. An output operand includes a plurality of output elements in an IFM. The output elements of an output operand may be stored sequentially in the output register file 1050 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

### Example Method of Pruning Weight

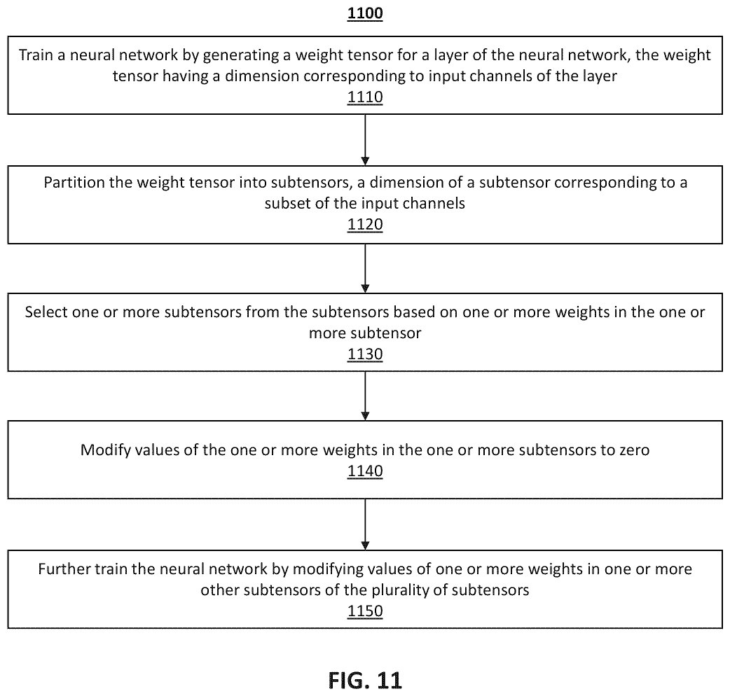

FIG. 11 is a flowchart showing a method 1100 of pruning weight, in accordance with various embodiments. The method 1100 may be performed by the DNN module 500 in FIG. 5. Although the method 1100 is described with reference to the flowchart illustrated in FIG. 11, many other methods for pruning weight may alternatively be used. For example, the order of execution of the steps in FIG. 11 may be changed. As another example, some of the steps may be changed, eliminated, or combined.

The DNN module 500 trains 1110 a neural network by generating a weight tensor for a layer of the neural network. The weight tensor has a dimension corresponding to input channels of the layer. In some embodiments, training the neural network comprises passing a first training dataset through at least part of the neural network a first number of times.

The DNN module 500 partitions 1120 the weight tensor into subtensors, a dimension of a subtensor corresponding to a subset of the input channels. In some embodiments, different subtensors have the same number of input channels. In some embodiments, the subtensors have the same spatial size.

The DNN module 500 selects 1130 one or more subtensors from the subtensors based on one or more weights in the one or more subtensor. In some embodiments, the DNN module 500 determines norms of the subtensors. The norm of a subtensor is determined based on values of weights in the subtensor. The one or more subtensors are selected based on the norms. One or more norms of the one or more subtensors are lower than one or more norms of the one or more other subtensors. The norm may be an L1 norm, L2 norm, or other types of norms.

The DNN module 500 modifies 1140 values of the one or more weights in the one or more subtensors to zero. In some embodiments, the layer has a plurality of weight tensors that comprises the weight tensor. The plurality of weight tensors corresponds to different output channels of the layer. Values of weights in a plurality of selected subtensors of the plurality of weight tensors are modified to zero. In some embodiments, each of the plurality of weight tensors has the same number of one or more selected subtensors. In some embodiments, the layer is executed by PEs arranged in a plurality of columns, a column comprising one or more PEs. Weights in different weight tensors are processed by different columns.

The DNN module 500 further trains 1150 the neural network by modifying values of one or more weights in one or more other subtensors of the subtensors. In some embodiments, further training the neural network comprises passing a second training dataset through at least part of the neural network a second number of times. The first number is greater than the second number.

### Example Computing Device

FIG. 12 is a block diagram of an example computing device 1200, in accordance with various embodiments. In some embodiments, the computing device 1200 can be used as at least part of the DNN accelerator 300. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for pruning weights in DNNs, e.g., the method 1100 described above in conjunction with FIG. 11 or some operations performed by the DNN module 500 (e.g., the training module 520, compressing module 530, etc.) described above in conjunction with FIG. 5. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (OR) code reader, any sensor, or a radio frequency identification (RFID) reader.

The computing device 1200 may have any desired form factor, such as a handheld or mobile computer system (e.g., a cell phone, a smart phone, a mobile Internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### SELECTED EXAMPLES

The following paragraphs provide various examples of the embodiments disclosed herein.

Example 1 provides a method for neural network training, the method including training a neural network by generating a weight tensor for a layer of the neural network, the weight tensor having a dimension corresponding to input channels of the layer; partitioning the weight tensor into subtensors, a dimension of a subtensor corresponding to a subset of the input channels; selecting one or more subtensors from the subtensors based on one or more weights in the one or more subtensor; modifying values of the one or more weights in the one or more subtensors to zero; and further training the neural network by modifying values of one or more weights in one or more other subtensors of the subtensors.

Example 2 provides the compute element of example 1, where the layer has a plurality of weight tensors that includes the weight tensor, the plurality of weight tensors corresponds to different output channels of the layer, and values of weights in a plurality of selected subtensors of the plurality of weight tensors are modified to zero.

Example 3 provides the compute element of example 2, where each of the plurality of weight tensors has the same number of one or more selected subtensors,

Example 4 provides the compute element of example 3, where the layer is executed by PEs arranged in a plurality of columns, a column including one or more PEs, and weights in different weight tensors are processed by different columns.

Example 5 provides the method of any one of examples 1-4, where different subtensors have the same number of input channels.

Example 6 provides the compute element of any one of examples 1-5, where selecting the one or more subtensors from the subtensors includes determining norms of the subtensors, a norm of a subtensor determined based on values of weights in the subtensor; and selecting the one or more subtensors based on the norms, where one or more norms of the one or more subtensors are lower than one or more norms of the one or more other subtensors.

Example 7 provides the compute element of any one of examples 1-6, where training the neural network includes passing a first training dataset through at least part of the neural network a first number of times, further training the neural network includes passing a second training dataset through at least part of the neural network a second number of times, and the first number is greater than the second number.

Example 8 provides one or more non-transitory computer-readable media storing instructions executable to perform operations for neural network training, the operations including training a neural network by generating a weight tensor for a layer of the neural network, the weight tensor having a dimension corresponding to input channels of the layer; partitioning the weight tensor into subtensors, a dimension of a subtensor corresponding to a subset of the input channels; selecting one or more subtensors from the subtensors based on one or more weights in the one or more subtensor; modifying values of the one or more weights in the one or more subtensors to zero; and further training the neural network by modifying values of one or more weights in one or more other subtensors of the subtensors.

Example 9 provides the one or more non-transitory computer-readable media of example 8, where the layer has a plurality of weight tensors that includes the weight tensor, the plurality of weight tensors corresponds to different output channels of the layer, and values of weights in a plurality of selected subtensors of the plurality of weight tensors are modified to zero.

Example 10 provides the one or more non-transitory computer-readable media of example 9, where each of the plurality of weight tensors has the same number of one or more selected subtensors.

Example 11 provides the one or more non-transitory computer-readable media of example 10, where the layer is executed by PEs arranged in a plurality of columns, a column including one or more PEs, and weights in different weight tensors are processed by different columns.

Example 12 provides the one or more non-transitory computer-readable media of any one of examples 8-11, where different subtensors have the same number of input channels.

Example 13 provides the one or more non-transitory computer-readable media of any one of examples 8-12, where selecting the one or more subtensors from the subtensors includes determining norms of the subtensors, a norm of a subtensor determined based on values of weights in the subtensor; and selecting the one or more subtensors based on the norms, where one or more norms of the one or more subtensors are lower than one or more norms of the one or more other subtensors.

Example 14 provides the one or more non-transitory computer-readable media of any one of examples 8-13, where training the neural network includes passing a first training dataset through at least part of the neural network a first number of times, further training the neural network includes passing a second training dataset through at least part of the neural network a second number of times, and the first number is greater than the second number.

Example 15 provides an apparatus, including a computer processor for executing computer program instructions; and a non-transitory computer-readable memory storing computer program instructions executable by the computer processor to perform operations including training a neural network by generating a weight tensor for a layer of the neural network, the weight tensor having a dimension corresponding to input channels of the layer, partitioning the weight tensor into subtensors, a dimension of a subtensor corresponding to a subset of the input channels, selecting one or more subtensors from the subtensors based on one or more weights in the one or more subtensor, modifying values of the one or more weights in the one or more subtensors to zero, and further training the neural network by modifying values of one or more weights in one or more other subtensors of the subtensors.

Example 16 provides the apparatus of example 15, where the layer has a plurality of weight tensors that includes the weight tensor, the plurality of weight tensors corresponds to different output channels of the layer, and values of weights in a plurality of selected subtensors of the plurality of weight tensors are modified to zero.

Example 17 provides the apparatus of example 16, where each of the plurality of weight tensors has the same number of one or more selected subtensors.

Example 18 provides the apparatus of example 17, where the layer is executed by PEs arranged in a plurality of columns, a column including one or more PEs, and weights in different weight tensors are processed by different columns.

Example 19 provides the apparatus of any one of examples 15-18, where different subtensors have the same number of input channels.

Example 20 provides the apparatus of any one of examples 15-49, where selecting the one or more subtensors from the subtensors includes determining norms of the subtensors, a norm of a subtensor determined based on values of weights in the subtensor; and selecting the one or more subtensors based on the norms, where one or more norms of the one or more subtensors are lower than one or more norms of the one or more other subtensors.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for neural network training, the method comprising:
training a neural network by generating a weight tensor for a layer of the neural network, the weight tensor having a dimension corresponding to input channels of the layer;
partitioning the weight tensor into subtensors, a dimension of a subtensor corresponding to a subset of the input channels;
selecting one or more subtensors from the subtensors based on one or more weights in the one or more subtensor;
modifying values of the one or more weights in the one or more subtensors to zero; and
further training the neural network by modifying values of one or more weights in one or more other subtensors of the subtensors,

2. The method of claim 1, wherein:
the layer has a plurality of weight tensors that comprises the weight tensor,
the plurality of weight tensors corresponds to different output channels of the layer, and
values of weights in a plurality of selected subtensors of the plurality of weight tensors are modified to zero.

3. The method of claim 2, wherein each of the plurality of weight tensors has the same number of one or more selected subtensors.

4. The method of claim 3, wherein:
the layer is executed by processing elements arranged in a plurality of columns, a column comprising one or more processing elements, and
weights in different weight tensors are processed by different columns.

5. The method of claim 1, wherein different subtensors have the same number of input channels.

6. The method of claim 1, wherein selecting the one or more subtensors from the subtensors comprises:
determining norms of the subtensors, a norm of a subtensor determined based on values of weights in the subtensor; and
selecting the one or more subtensors based on the norms, wherein one or more norms of the one or more subtensors are lower than one or more norms of the one or more other subtensors.

7. The method of claim 1, wherein:
training the neural network comprises passing a first training dataset through at least part of the neural network a first number of times,
further training the neural network comprises passing a second training dataset through at least part of the neural network a second number of times, and
the first number is greater than the second number.

8. One or more non-transitory computer-readable media storing instructions executable to perform operations for neural network training, the operations comprising:
training a neural network by generating a weight tensor for a layer of the neural network, the weight tensor having a dimension corresponding to input channels of the layer;
partitioning the weight tensor into subtensors, a dimension of a subtensor corresponding to a subset of the input channels;
selecting one or more subtensors from the subtensors based on one or more weights in the one or more subtensor;
modifying values of the one or more weights in the one or more subtensors to zero; and
further training the neural network by modifying values of one or more weights in one or more other subtensors of the subtensors.

9. The one or more non-transitory computer-readable media of claim 8, wherein:
the layer has a plurality of weight tensors that comprises the weight tensor,
the plurality of weight tensors corresponds to different output channels of the layer, and
values of weights in a plurality of selected subtensors of the plurality of weight tensors are modified to zero.

10. The one or more non-transitory computer-readable media of claim 9, wherein each of the plurality of weight tensors has the same number of one or more selected subtensors.

11. The one or more non-transitory computer-readable media of claim 10, wherein:
the layer is executed by processing elements arranged in a plurality of columns, a column comprising one or more processing elements, and
weights in different weight tensors are processed by different columns.

12. The one or more non-transitory computer-readable media of claim 8, wherein different subtensors have the same number of input channels.

13. The one or more non-transitory computer-readable media of claim 8, wherein selecting the one or more subtensors from the subtensors comprises:
determining norms of the subtensors, a norm of a subtensor determined based on values of weights in the subtensor; and
selecting the one or more subtensors based on the norms, wherein one or more norms of the one or more subtensors are lower than one or more norms of the one or more other subtensors.

14. The one or more non-transitory computer-readable media of claim 8, wherein:
training the neural network comprises passing a first training dataset through at least part of the neural network a first number of times,
further training the neural network comprises passing a second training dataset through at least part of the neural network a second number of times, and
the first number is greater than the second number.

15. An apparatus, comprising:
a computer processor for executing computer program instructions; and
a non-transitory computer-readable memory storing computer program instructions executable by the computer processor to perform operations comprising:
training a neural network by generating a weight tensor for a layer of the neural network, the weight tensor having a dimension corresponding to input channels of the layer,
partitioning the weight tensor into subtensors, a dimension of a subtensor corresponding to a subset of the input channels,
selecting one or more subtensors from the subtensors based on one or more weights in the one or more subtensor,
modifying values of the one or more weights in the one or more subtensors to zero, and
further training the neural network by modifying values of one or more weights in one or more other subtensors of the subtensors.

16. The apparatus of claim 15, wherein:
the layer has a plurality of weight tensors that comprises the weight tensor,
the plurality of weight tensors corresponds to different output channels of the layer, and
values of weights in a plurality of selected subtensors of the plurality of weight tensors are modified to zero.

17. The apparatus of claim 16, wherein each of the plurality of weight tensors has the same number of one or more selected subtensors.

18. The apparatus of claim 17, wherein:
the layer is executed by processing elements arranged in a plurality of columns, a column comprising one or more processing elements, and
weights in different weight tensors are processed by different columns.

19. The apparatus of claim 15, wherein different subtensors have the same number of input channels.

20. The apparatus of claim 15, wherein selecting the one or more subtensors from the subtensors comprises:
determining norms of the subtensors, a norm of a subtensor determined based on values of weights in the subtensor; and
selecting the one or more subtensors based on the norms, wherein one or more norms of the one or more subtensors are lower than one or more norms of the one or more other subtensors.
